(19) United States
(12) Patent Application Publication
(10) Pub. No.: US 2026/0197594 A1
(43) Pub. Date: Jul. 9, 2026

(54) MICROPHONE SELF-CHECKING CIRCUIT

(71) Applicants: ZILLTEK TECHNOLOGY (SHANGHAI) CORP., Shanghai (CN); ZILLTEK TECHNOLOGY CORP., Hsinchu (TW)

(72) Inventors: Jinghua YE, Shanghai (CN); Chen-Chi CHIU, Hsinchu City (TW); Zihao YE, Shanghai (CN)

(73) Assignees: ZILLTEK TECHNOLOGY (SHANGHAI) CORP., Shanghai (CN); ZILLTEK TECHNOLOGY CORP., Hsinchu (TW)

(21) Appl. No.: 19/427,838

(22) Filed: Dec. 19, 2025

(30) Foreign Application Priority Data
Jan. 8, 2025 (CN) 202510035203.2

(51) Int. Cl. H04R 29/00; H04R 3/00

(52) U.S. Cl. CPC H04R 29/004; H04R 3/00; H04R 29/008

(57) ABSTRACT

A microphone self-checking circuit, comprising a self-excited oscillator for generating a signal with a set frequency; a capacitor driver, an output end of the capacitor driver is respectively connected to a first end and a second end of a ceramic capacitor; a signal amplifier, an input end of the signal amplifier is connected to an output end of a microphone, and the signal amplifier outputs an amplified signal; a first comparator, an input end of the first comparator is connected to an output end of the signal amplifier; a second comparator, an input end of the second comparator is connected to an output end of the first comparator; a first indicating lamp, which is connected between a second power supply voltage and the output end of the first comparator; a second indicating lamp, which is connected between an output end of the second comparator and a grounding end.

### FIELD OF THE INVENTION

The present invention relates to the field of micro-electromechanical technology, and in particular, to a microphone self-checking circuit.

### DESCRIPTION OF THE RELATED ART

Autonomous vehicles require not only internal installation of microphones but also external sensors including microphones to enhance the vehicle's ability to perceive ambient sounds such as alarms and horns. This acoustic data, when combined with other sensor data, improves the vehicle's responsiveness to emergency situations. Existing microphones, if functionally abnormal, may prevent timely vehicle reactions to emergencies, leading to potentially severe consequences.

### SUMMARY OF THE INVENTION

Based on the above issues, the invention provides a microphone self-checking circuit.

A microphone self-checking circuit, comprising
a self-excited oscillator for generating a signal with a set frequency;
a capacitor driver, connected to the self-excited oscillator, an output end of the capacitor driver is respectively connected to a first end and a second end of a ceramic capacitor;
a signal amplifier, an input end of the signal amplifier is connected to an output end of a microphone, and the signal amplifier outputs an amplified signal;
a first comparator, an input end of the first comparator is connected to an output end of the signal amplifier;
a second comparator, an input end of the second comparator is connected to an output end of the first comparator;
a first indicating lamp, connected between a second power supply voltage and the output end of the first comparator;
a second indicating lamp, connected between an output end of the second comparator and a grounding end.

The microphone self-checking circuit according to the invention, the microphone comprises an acoustic sensor and a specific integrated circuit chip mounted in an acoustic cavity of a circuit substrate, wherein the ceramic capacitor is located inside the microphone.

The microphone self-checking circuit according to the invention, the capacitor driver is connected to a second power supply voltage through a self-checking switch, and the input terminal of the first comparator is connected to the grounding end through a reset switch.

The microphone self-checking circuit according to the invention, the self-excited oscillator comprises a first chip, wherein an IA terminal of the first chip is connected to a first terminal of a first capacitor through a first resistor, a second terminal of the first capacitor is connected to the grounding end through a third capacitor, and a fourth resistor is connected in parallel with the third capacitor;
the second terminal of the first capacitor is connected, sequentially through a second capacitor and a third resistor, to a first terminal of a sixth capacitor, a second terminal of the sixth capacitor is connected to an OB terminal of the first chip, and the first terminal of the sixth capacitor is further connected to the grounding end through a seventh resistor;
the IA terminal of the first chip is connected to an OA terminal of the first chip through a second resistor; a VDD terminal of the first chip is connected to a second power supply voltage, and the VDD terminal of the first chip is further connected to the grounding end through a seventh capacitor;
a BYPASS terminal of the first chip is connected to the grounding end through a fourth capacitor; an IB terminal of the first chip is connected, sequentially through a fifth resistor and a fifth capacitor, to the OA terminal of the first chip.

The microphone self-checking circuit according to the invention, the signal with the set frequency comprises a 9 kHz signal, the first indicator light is a red indicator light, the second indicator light is a green indicator light, and the ceramic capacitor is a multilayer ceramic capacitor.

The microphone self-checking circuit according to the invention, the capacitor driver comprises a second chip, wherein an IA terminal of the second chip is connected to the second terminal of a sixth capacitor through an eighth resistor and an eighth capacitor; an SD terminal of the second chip is connected to a second power supply voltage through the self-checking switch, and the SD terminal of the second chip is further connected to an SD terminal of the first chip through a ninth resistor; a MICBIAS terminal of the second chip is connected to the grounding end through a ninth capacitor; an IB terminal of the second chip is connected to an OA terminal of the second chip through a tenth resistor and a tenth capacitor; the IB terminal of the second chip is connected to an OB terminal of the second chip through an eleventh resistor; a VDD terminal of the second chip is connected to a first power supply voltage, and the VDD terminal of the second chip is further connected to the grounding end through an eleventh capacitor; the IA terminal of the second chip is connected to the OA terminal of the second chip through a twelfth capacitor, and a twelfth resistor is connected in parallel across two ends of the twelfth capacitor; the OB terminal of the second chip is connected to a first terminal of a thirteenth capacitor, and a second terminal of the thirteenth capacitor is connected to the grounding end through a thirteenth resistor; the OA terminal of the second chip is connected to a first terminal of a fourteenth capacitor, and a second terminal of the fourteenth capacitor is connected to the first power supply voltage through a fourteenth resistor; and the SD terminal of the second chip is further connected to the grounding end through a fifteenth resistor.

The microphone self-checking circuit according to the invention, an FBR_1 terminal of the microphone is connected to the second terminal of the fourteenth capacitor;
a CONFIG2 terminal of the microphone is connected to the second terminal of the thirteenth capacitor;
a VOUT1 terminal of the microphone is connected to a first terminal of a sixteenth resistor;
a second terminal of the sixteenth resistor outputs a microphone output signal;
the second terminal of the sixteenth resistor is connected to a VOUT2 terminal of the microphone through a seventeenth resistor;
a VDD terminal of the microphone is connected to a second power supply voltage and is connected to the grounding end through a fifteenth capacitor.

The microphone self-checking circuit according to the invention, the signal amplifier comprises a third chip, wherein an IA terminal of the third chip is connected, sequentially through an eighteenth resistor and a sixteenth capacitor, to the microphone output signal; an SD terminal of the third chip is connected to the SD terminal of the first chip; a bypass terminal of the third chip is connected to the grounding end through a seventeenth capacitor; an IB terminal of the third chip is connected to an OA terminal of the third chip through a nineteenth resistor and an eighteenth capacitor; the IB terminal of the third chip is further connected to an OB terminal of the third chip through a twentieth resistor, and a nineteenth capacitor is connected in parallel across two ends of the twentieth resistor; a VDD terminal of the third chip is connected to the second power supply voltage, and the VDD terminal of the third chip is further connected to the grounding end through a twentieth capacitor.

The microphone self-checking circuit according to the invention, comprises a fourth chip, wherein the fourth chip includes the first comparator and the second comparator;
a first input terminal of the fourth chip is connected to the OB terminal of the third chip through a twenty-first resistor;
a second input terminal of the fourth chip is connected to the second power supply voltage through a twenty-second resistor, and the second input terminal of the fourth chip is further connected to the grounding end through a twenty-third resistor;
the first input terminal of the fourth chip is connected to the grounding end through the reset switch, and the first input terminal of the fourth chip is further connected to an OUTB output terminal of the fourth chip through a twenty-fourth resistor;
an OUTA output terminal of the fourth chip is connected to a third input terminal, and the OUTA output terminal of the fourth chip is further connected to the second power supply voltage through the first indicator light and a twenty-fifth resistor;
a fourth input terminal of the fourth chip is connected to the grounding end through a twenty-sixth resistor, and the fourth input terminal of the fourth chip is connected to the second power supply voltage through a twenty-seventh resistor;
an output signal of an OUTB output terminal of the fourth chip is connected, sequentially through a twenty-eighth resistor and the second indicator light, to the grounding end;
a V+ terminal of the fourth chip is connected to the second power supply voltage, and the V+ terminal of the fourth chip is further connected to the grounding end through a twenty-first capacitor.

The microphone self-checking circuit according to the invention, a low-dropout linear regulator converts the first power supply voltage into the second power supply voltage;
a VIN terminal of the low-dropout linear regulator is connected to the first power supply voltage, and the VIN terminal of the low-dropout linear regulator is further connected to the grounding end through a twenty-second capacitor;
the VIN terminal of the low-dropout linear regulator is connected to an EN terminal of the low-dropout linear regulator;
a Vout terminal of the low-dropout linear regulator outputs the second power supply voltage;
the Vout terminal of the low-dropout linear regulator is connected to the grounding end through a twenty-ninth resistor and a third indicator light;
a twenty-third capacitor is connected between the Vout terminal of the low-dropout linear regulator and the grounding end;
a GND terminal of the low-dropout linear regulator is connected to the grounding end.

Beneficial effects: the present invention generates the signal with the set frequency through a self-excited oscillator, which is amplified to drive a ceramic capacitor to produce sound. The microphone captures the sound generated by the ceramic capacitor, and the output signal of the microphone is amplified and compared with a set threshold. According to the comparison result, a first indicator light or a second indicator light is driven to illuminate, enabling detection of whether the microphone is functioning normally and providing timely alarm indication when a fault is detected.

### BRIEF DESCRIPTION OF THE DRAWINGS

FIG. 1 is a schematic block diagram of the microphone self-checking circuit of the present invention;

FIG. 2 is a schematic structural diagram of the microphone of the present invention;

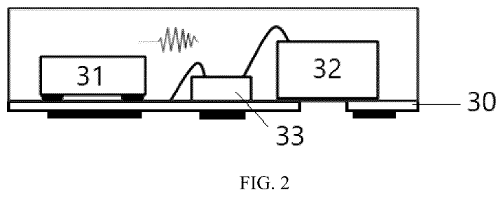

FIG. 3 is a schematic diagram of chip connections in the microphone self-checking circuit of the present invention;

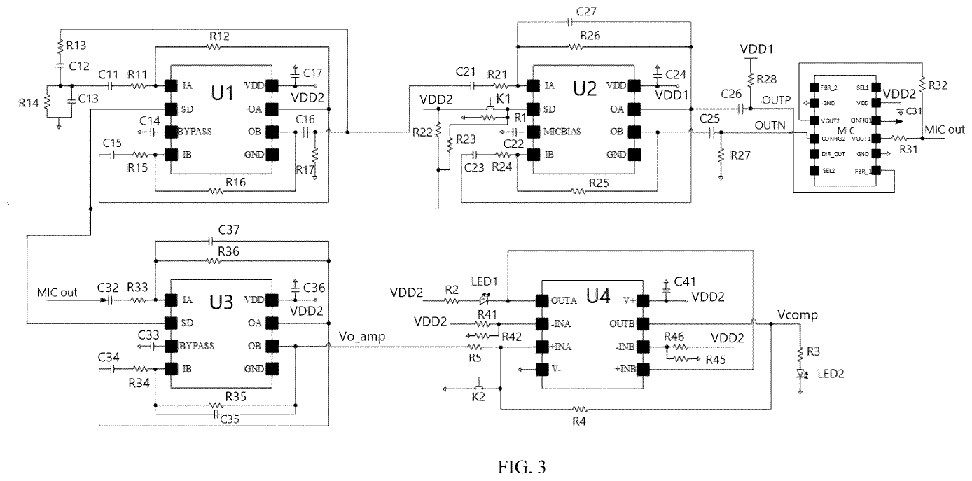

FIG. 4 is a schematic diagram of connections of the low-dropout linear regulator of the present invention.

### DETAILED DESCRIPTION

The technical solutions in the embodiments of the present invention will be clearly and completely described below with reference to the accompanying drawings in the embodiments of the present invention. It is apparent that the described embodiments are only a part of the embodiments of the present invention, rather than all of the embodiments. All other embodiments obtained by those of ordinary skill in the art based on the embodiments of the present invention without creative efforts shall fall within the scope of protection of the present invention.

It should be noted that the embodiments of the present invention and the features in the embodiments may be combined with each other without conflict.

The present invention is further described below with reference to the accompanying drawings and specific embodiments, but this should not be construed as limiting the invention.

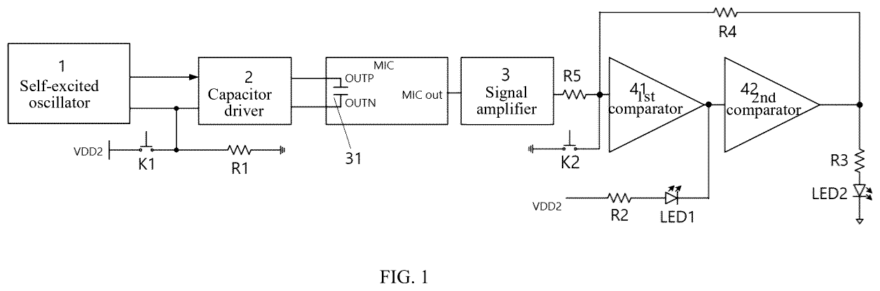

Referring to FIG. 1, a microphone self-checking circuit, comprising:
a self-excited oscillator 1 for generating a signal with a set frequency;
a capacitor driver 2, connected to the self-excited oscillator 1, an output end of the capacitor driver 2 is respectively connected to a first end OUTP and a second end OUTN of a ceramic capacitor 31;
a signal amplifier 3, an input end of the signal amplifier 3 is connected to an output end of a microphone MIC, and the signal amplifier 3 outputs an amplified signal Vo_amp;
a first comparator 41, an input end of the first comparator 41 is connected to an output end of the signal amplifier 3;
a second comparator 42, an input end of the second comparator 42 is connected to an output end of the first comparator 41;
a first indicating lamp LED1, connected between a second power supply voltage VDD2 and the output end of the first comparator 41;
a second indicating lamp LED2, connected between an output end of the second comparator 42 and a grounding end.

The present invention generates the signal of the set frequency through a self-excited oscillator, the signal is amplified to drive a ceramic capacitor to produce sound. The microphone captures the sound generated by the ceramic capacitor, and the output signal of the microphone is amplified and compared with a set threshold. The comparison result drives a first indicator light or a second indicator light to illuminate, enabling detection of whether the microphone is functioning normally and providing timely alarm indication when a fault is detected.

In a preferred embodiment of the invention, the microphone MIC comprises an acoustic sensor 32 and a specific integrated circuit chip 33 mounted in an acoustic cavity of a circuit substrate 30, wherein the ceramic capacitor 31 is located on the circuit substrate 30 and in the same acoustic cavity.

The present invention enables integrated self-checking functionality for the microphone by incorporating the ceramic capacitor into the microphone's package structure.

In a preferred embodiment of the invention, the signal with the set frequency comprises a 9 kHz signal, the first indicator light is a red indicator light, the second indicator light is a green indicator light, and the ceramic capacitor is a multilayer ceramic capacitor.

The comparison result of the comparator is indicated by a red indicator light and a green indicator light, wherein the green indicator light indicates normal operation of the microphone, and the red indicator light indicates abnormal operation.

In a preferred embodiment of the invention, the self-excited oscillator 1 comprises a first chip U1, wherein an IA terminal of the first chip U1 is connected to a first terminal of a first capacitor C11 through a first resistor R11, a second terminal of the first capacitor C11 is connected to the grounding end through a third capacitor C13, and a fourth resistor R14 is connected in parallel with the third capacitor C13;
the second terminal of the first capacitor C11 is connected, sequentially through a second capacitor C12 and a third resistor R13, to a first terminal of a sixth capacitor C16, a second terminal of the sixth capacitor C16 is connected to an OB terminal of the first chip U1, and the first terminal of the sixth capacitor C16 is further connected to the grounding end through a seventh resistor R17;
the IA terminal of the first chip U1 is connected to an OA terminal of the first chip U1 through a second resistor R12; a VDD terminal of the first chip U1 is connected to a second power supply voltage VDD2, and the VDD terminal of the first chip U1 is further connected to the grounding end through a seventh capacitor C17;
a BYPASS terminal of the first chip U1 is connected to the grounding end through a fourth capacitor C14; an IB terminal of the first chip U1 is connected, sequentially through a fifth resistor R15 and a fifth capacitor C15, to the OA terminal of the first chip U1.

In a preferred embodiment of the invention, the capacitor driver 2 comprises a second chip U2, wherein an IA terminal of the second chip U2 is connected to the second terminal of a sixth capacitor C16 through an eighth resistor R21 and an eighth capacitor C21; an SD terminal of the second chip U2 is connected to a second power supply voltage VDD2 through the self-checking switch K1, and the SD terminal of the second chip U2 is further connected to an SD terminal of the first chip U1 through a ninth resistor R22; a MICBIAS terminal of the second chip U2 is connected to the grounding end through a ninth capacitor C22; an IB terminal of the second chip U2 is connected to an OA terminal of the second chip U2 through a tenth resistor R24 and a tenth capacitor C23; the IB terminal of the second chip U2 is connected to an OB terminal of the second chip U2 through an eleventh resistor R25; a VDD terminal of the second chip U2 is connected to a first power supply voltage VDD1, and the VDD terminal of the second chip U2 is further connected to the grounding end through an eleventh capacitor C24; the IA terminal of the second chip U2 is connected to the OA terminal of the second chip U2 through a twelfth capacitor C27, and a twelfth resistor R26 is connected in parallel across two ends of the twelfth capacitor C27; the OB terminal of the second chip U2 is connected to a first terminal of a thirteenth capacitor C25, and a second terminal of the thirteenth capacitor C25 is connected to the grounding end through a thirteenth resistor R27; the OA terminal of the second chip U2 is connected to a first terminal of a fourteenth capacitor C26, and a second terminal of the fourteenth capacitor C26 is connected to the first power supply voltage VDD1 through a fourteenth resistor R28; and the SD terminal of the second chip U2 is further connected to the grounding end through a fifteenth resistor R1.

The aforementioned first chip U1, second chip U2, and third chip U3 are operational amplifier chips.

In a preferred embodiment of the invention, an FBR_1 terminal of the microphone MIC is connected to the second terminal of the fourteenth capacitor C26;
a CONFIG2 terminal of the microphone MIC is connected to the second terminal of the thirteenth capacitor C25;
a VOUT1 terminal of the microphone MIC is connected to a first terminal of a sixteenth resistor R31;
a second terminal of the sixteenth resistor R31 outputs a microphone output signal MIC our;
the second terminal of the sixteenth resistor R31 is connected to a VOUT2 terminal of the microphone MIC through a seventeenth resistor R32;
a VDD terminal of the microphone MIC is connected to a second power supply voltage VDD2 and is connected to the grounding end through a fifteenth capacitor C31.

In a preferred embodiment of the invention, the signal amplifier 3 comprises a third chip U3, wherein an IA terminal of the third chip U3 is connected, sequentially through an eighteenth resistor R33 and a sixteenth capacitor C32, to the output signal MIC out of the microphone; an SD terminal of the third chip U3 is connected to the SD terminal of the first chip U1; a bypass terminal of the third chip U3 is connected to the grounding end through a seventeenth capacitor C33; an IB terminal of the third chip U3 is connected to an OA terminal of the third chip U3 through a nineteenth resistor R34 and an eighteenth capacitor C34; the IB terminal of the third chip U3 is further connected to an OB terminal of the third chip U3 through a twentieth resistor R35, and a nineteenth capacitor C35 is connected in parallel across two ends of the twentieth resistor R35; a VDD terminal of the third chip U3 is connected to the second power supply voltage VDD2, and the VDD terminal of the third chip U3 is further connected to the grounding end through a twentieth capacitor C36.

In a preferred embodiment of the invention, comprises a fourth chip U4, wherein the fourth chip U4 includes the first comparator 41 and the second comparator 42;
a first input terminal +INA of the fourth chip U4 is connected to the OB terminal of the third chip U3 through a twenty-first resistor R5;
a second input terminal −INA of the fourth chip U4 is connected to the second power supply voltage VDD2 through a twenty-second resistor R41, and the second input terminal −INA of the fourth chip U4 is further connected to the grounding end through a twenty-third resistor R42;
the first input terminal +INA of the fourth chip U4 is connected to the ground terminal through the reset switch K2, and the first input terminal +INA of the fourth chip U4 is further connected to an OUTB output terminal of the fourth chip U4 through a twenty-fourth resistor R4;
an OUTA output terminal of the fourth chip U4 is connected to a third input terminal +INB, and the OUTA output terminal of the fourth chip U4 is further connected to the second power supply voltage VDD2 through the first indicator light LED 2 and a twenty-fifth resistor R2;
a fourth input terminal −INB of the fourth chip U4 is connected to the grounding end through a twenty-sixth resistor R45, and the fourth input terminal −INB of the fourth chip U4 is connected to the second power supply voltage VDD2 through a twenty-seventh resistor R46;
an output signal Vcomp of an OUTB output terminal of the fourth chip U4 is connected, sequentially through a twenty-eighth resistor R3 and the second indicator light LED2, to the grounding end;
a V+ terminal of the fourth chip U4 is connected to the second power supply voltage VDD2, and the V+ terminal of the fourth chip U4 is further connected to the grounding end through a twenty-first capacitor C41.

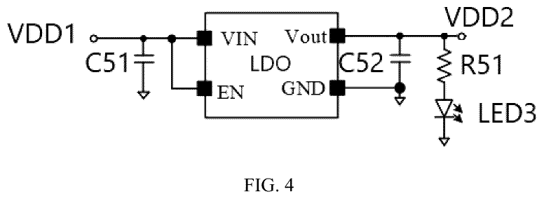

Referring to FIG. 4, in a preferred embodiment of the invention, a low-dropout linear regulator LDO converts the first power supply voltage VDD1 into the second power supply voltage VDD2;
a VIN terminal of the low-dropout linear regulator LDO is connected to the first power supply voltage VDD1, and the VIN terminal of the low-dropout linear regulator LDO is further connected to the grounding end through a twenty-second capacitor C51;
the VIN terminal of the low-dropout linear regulator LDO is connected to an EN terminal of the low-dropout linear regulator LDO;
a Vout terminal of the low-dropout linear regulator LDO outputs the second power supply voltage VDD2;
the Vout terminal of the low-dropout linear regulator LDO is connected to the grounding end through a twenty-ninth resistor R51 and a third indicator light LED3;
a twenty-third capacitor C52 is connected between the Vout terminal of the low-dropout linear regulator LDO and the grounding end;
a GND terminal of the low-dropout linear regulator LDO is connected to the grounding end.

The first power supply voltage is 5V, and the second power supply voltage is 3.3V, which supply power to the operational amplifier chips and the microphone.

Specific structures of typical embodiments are provided through the description and drawings, and other transformations may be made based on the spirit of the present invention. Although the above invention presents existing preferred embodiments, these contents are not to be construed as limitations.

Various changes and modifications will undoubtedly become apparent to those skilled in the art after reading the foregoing description. Accordingly, the appended claims should be construed as covering all changes and modifications that fall within the true intent and scope of the present invention. Any and all equivalent scopes and contents within the scope of the claims shall be deemed to remain within the intent and scope of the present invention.

1. A microphone self-checking circuit, comprising
a self-excited oscillator for generating a signal with a set frequency;
a capacitor driver, connected to the self-excited oscillator, an output end of the capacitor driver is respectively connected to a first end and a second end of a ceramic capacitor;
a signal amplifier, an input end of the signal amplifier is connected to an output end of a microphone, and the signal amplifier outputs an amplified signal;
a first comparator, an input end of the first comparator is connected to an output end of the signal amplifier;
a second comparator, an input end of the second comparator is connected to an output end of the first comparator;
a first indicating lamp, connected between a second power supply voltage and the output end of the first comparator;
a second indicating lamp, connected between an output end of the second comparator and a grounding end.

2. The microphone self-checking circuit of claim 1, wherein the microphone comprises an acoustic sensor and a specific integrated circuit chip mounted in an acoustic cavity of a circuit substrate, wherein the ceramic capacitor is located inside the microphone.

3. The microphone self-checking circuit of claim 1, wherein the capacitor driver is connected to a second power supply voltage through a self-checking switch, and the input terminal of the first comparator is connected to the grounding end through a reset switch.

4. The microphone self-checking circuit of claim 3, wherein the self-excited oscillator comprises a first chip, wherein an IA terminal of the first chip is connected to a first terminal of a first capacitor through a first resistor, a second terminal of the first capacitor is connected to the grounding end through a third capacitor, and a fourth resistor is connected in parallel with the third capacitor;
the second terminal of the first capacitor is connected, sequentially through a second capacitor and a third resistor, to a first terminal of a sixth capacitor, a second terminal of the sixth capacitor is connected to an OB terminal of the first chip, and the first terminal of the sixth capacitor is further connected to the grounding end through a seventh resistor;
the IA terminal of the first chip is connected to an OA terminal of the first chip through a second resistor; a VDD terminal of the first chip is connected to a second power supply voltage, and the VDD terminal of the first chip is further connected to the grounding end through a seventh capacitor;
a BYPASS terminal of the first chip is connected to the grounding end through a fourth capacitor; an IB terminal of the first chip is connected, sequentially through a fifth resistor and a fifth capacitor, to the OA terminal of the first chip.

5. The microphone self-checking circuit of claim 1, wherein the signal with the set frequency comprises a 9 kHz signal, the first indicator light is a red indicator light, the second indicator light is a green indicator light, and the ceramic capacitor is a multilayer ceramic capacitor.

6. The microphone self-checking circuit of claim 4, wherein the capacitor driver comprises a second chip, wherein an IA terminal of the second chip is connected to the second terminal of a sixth capacitor through an eighth resistor and an eighth capacitor; an SD terminal of the second chip is connected to a second power supply voltage through the self-checking switch, and the SD terminal of the second chip is further connected to an SD terminal of the first chip through a ninth resistor; a MICBIAS terminal of the second chip is connected to the grounding end through a ninth capacitor; an IB terminal of the second chip is connected to an OA terminal of the second chip through a tenth resistor and a tenth capacitor; the IB terminal of the second chip is connected to an OB terminal of the second chip through an eleventh resistor; a VDD terminal of the second chip is connected to a first power supply voltage, and the VDD terminal of the second chip is further connected to the grounding end through an eleventh capacitor; the IA terminal of the second chip is connected to the OA terminal of the second chip through a twelfth capacitor, and a twelfth resistor is connected in parallel across two ends of the twelfth capacitor; the OB terminal of the second chip is connected to a first terminal of a thirteenth capacitor, and a second terminal of the thirteenth capacitor is connected to the grounding end through a thirteenth resistor; the OA terminal of the second chip is connected to a first terminal of a fourteenth capacitor, and a second terminal of the fourteenth capacitor is connected to the first power supply voltage through a fourteenth resistor; and the SD terminal of the second chip is further connected to the grounding end through a fifteenth resistor.

7. The microphone self-checking circuit of claim 6, wherein an FBR_1 terminal of the microphone is connected to the second terminal of the fourteenth capacitor;
a CONFIG2 terminal of the microphone is connected to the second terminal of the thirteenth capacitor;
a VOUT1 terminal of the microphone is connected to a first terminal of a sixteenth resistor;
a second terminal of the sixteenth resistor outputs a microphone output signal;
the second terminal of the sixteenth resistor is connected to a VOUT2 terminal of the microphone through a seventeenth resistor;
a VDD terminal of the microphone is connected to a second power supply voltage and is connected to the grounding end through a fifteenth capacitor.

8. The microphone self-checking circuit of claim 7, wherein the signal amplifier comprises a third chip, wherein an IA terminal of the third chip is connected, sequentially through an eighteenth resistor and a sixteenth capacitor, to the microphone output signal; an SD terminal of the third chip is connected to the SD terminal of the first chip; a bypass terminal of the third chip is connected to the grounding end through a seventeenth capacitor; an IB terminal of the third chip is connected to an OA terminal of the third chip through a nineteenth resistor and an eighteenth capacitor; the IB terminal of the third chip is further connected to an OB terminal of the third chip through a twentieth resistor, and a nineteenth capacitor is connected in parallel across two ends of the twentieth resistor; a VDD terminal of the third chip is connected to the second power supply voltage, and the VDD terminal of the third chip is further connected to the grounding end through a twentieth capacitor.

9. The microphone self-checking circuit of claim 8, comprises a fourth chip, wherein the fourth chip includes the first comparator and the second comparator;
a first input terminal of the fourth chip is connected to the OB terminal of the third chip through a twenty-first resistor;
a second input terminal of the fourth chip is connected to the second power supply voltage through a twenty-second resistor, and the second input terminal of the fourth chip is further connected to the grounding end through a twenty-third resistor;
the first input terminal of the fourth chip is connected to the grounding end through the reset switch, and the first input terminal of the fourth chip is further connected to an OUTB output terminal of the fourth chip through a twenty-fourth resistor;
an OUTA output terminal of the fourth chip is connected to a third input terminal, and the OUTA output terminal of the fourth chip is further connected to the second power supply voltage through the first indicator light and a twenty-fifth resistor;
a fourth input terminal of the fourth chip is connected to the grounding end through a twenty-sixth resistor, and the fourth input terminal of the fourth chip is connected to the second power supply voltage through a twenty-seventh resistor;
an output signal of an OUTB output terminal of the fourth chip is connected, sequentially through a twenty-eighth resistor and the second indicator light, to the grounding end;
a V+ terminal of the fourth chip is connected to the second power supply voltage, and the V+ terminal of the fourth chip is further connected to the grounding end through a twenty-first capacitor.

10. The microphone self-checking circuit of claim 1, wherein a low-dropout linear regulator converts the first power supply voltage into the second power supply voltage;
a VIN terminal of the low-dropout linear regulator is connected to the first power supply voltage, and the VIN terminal of the low-dropout linear regulator is further connected to the grounding end through a twenty-second capacitor;
the VIN terminal of the low-dropout linear regulator is connected to an EN terminal of the low-dropout linear regulator;
a Vout terminal of the low-dropout linear regulator outputs the second power supply voltage;
the Vout terminal of the low-dropout linear regulator is connected to the grounding end through a twenty-ninth resistor and a third indicator light;
a twenty-third capacitor is connected between the Vout terminal of the low-dropout linear regulator and the grounding end;
a GND terminal of the low-dropout linear regulator is connected to the grounding end.
